(19) United States
(12) Patent Application Publication
(10) Pub. No.: US 2007/0196595 A1
(43) Pub. Date: Aug. 23, 2007

(54) Polysaccharide materials with hydroxylated polymers in ink receiving media

(75) Inventor: Didier J. Martin, Givry (FR)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/348,767

(22) Filed: Feb. 7, 2006

(51) Int. Cl. B41M 5/50

(52) U.S. Cl. 428/32.24

(57) ABSTRACT

The present invention relates to an ink receiving media comprising at least two receiving layers on a support, wherein the layer closest to the support comprises inorganic particles, polysaccharide in combination with guar gum and polyvinyl alcohol, and the layer farthest from the support comprises polysaccharide in combination with polyvinyl alcohol. The present invention also relates to an inkjet receiving media comprising at least two preferably thermoreversible receiving layers on a support, wherein the layer closest to the support comprises inorganic particles, carrageenan κ or carrageenan κ/ι in combination with guar gum and polyvinyl alcohol, and the layer farthest from the support comprises polymer materials based on carrageenan κ or carrageenan κ/ι in combination with polyvinyl alcohol.

### CROSS REFERENCE TO RELATED APPLICATIONS

Reference is made to commonly assigned, co-pending U.S. Patent Applications: Ser. No. ______ by Didier Martin (Docket 88478) filed of even date herewith entitled “COATING METHOD OF MATERIAL FOR INKJET PRINTING”; Ser. No. ______ by Didier Martin (Docket 86917) filed of even date herewith entitled “MATERIAL FOR FORMING IMAGES BY INKJET PRINTING”; Ser. No. by Didier Martin (Docket 86918) filed of even date herewith entitled “MATERIAL FOR FORMING IMAGES BY INKJET PRINTING”; and Ser. No. ______ by Didier Martin (Docket 91932) filed of even date herewith entitled “GELS OF POLYSACCHARIDE, FLUORINATED SURFACTANT AND PARTICLES”, the disclosures of which are incorporated herein by reference.

### FIELD OF THE INVENTION

The present invention relates to a recording medium with at least two ink receiving layers, having a good image printing quality based on excellent ink absorption speed, good drying characteristics, good light and ozone fastness and gloss.

### BACKGROUND OF THE INVENTION

In general, to form a film or coating on a flexible support, a solution containing the desired film material is coated onto the support and dried. For high productivity and lower costs, these coatings are applied to continuous webs at high speeds and dried in an oven. Because of air impingement during drying and artifacts from the actual coating application method, coating defects may occur, for example, non-uniformity in thickness and streaks. For applications that require a high degree of coating uniformity, such as high quality photographic media and inkjet media, this problem may be solved by using coating solutions that contain a thermoreversible gelling material such as gelatin. After applying the thermoreversible gelling solution to the web, the coating is cooled to gel the coating. Very few materials are available that undergo a thermoreversible gelling behavior. Furthermore, the use of swelling material, for example, gelatin, for inkjet media does not achieve high performances in terms of dry ink fastness. One type of inkjet media of photographic quality having reasonable drying properties was previously prepared using non-microporous film structure based on swellable materials. The gelatin material has the ability to overcome smudge defects, but exhibits poor drying properties.

Another approach is based on the use of micro-porous inorganic particles such as silica, alumina hydrates and their mixed oxide nanostructured particles, such as those prepared by combining silica and alumina in a homogeneous structure or structured core/shell-like ones. Such media exhibit good drying property, but poor gloss level based on particle/particle or particle/binder interactions. In order to increase the gloss, the micro-porous layer may be calendered. The use of calendaring increases drastically the manufacturing cost related to cost investment, energy consumption and reduced throughput productivity.

The combination of multi-layer materials with both a swellable layer and a distinctive microporous layer suffer basically from the same quality problems: the outer micro-porous layer results in a bad dye fading or light fading behavior and poor gloss levels, and the outer swellable layer with a microporous sublayer does not solve the drying problems related to ink adsorption, coalescence, bleed or spread defect.

U.S. Pat. No. 4,898,810 discloses the use of gelatin plus Gellan gum to provide improved setting property. For this invention, the main binder is the gelatin material and the main drawbacks of gelatin material for inkjet application are maintained in terms of curl propensity, and swelling propensity. Furthermore, gellan gum, such as Gelrite (TM) supplied by KELCO or MERCK, when compared to the present inventive use of carrageenan, does not provide gel formation even at 0.5% weight content and even with polyvinyl alcohol. To achieve gel formation at such content, the addition of salt, that is, sodium chloride at 0.1%, is required and provides a soft and brittle gel. In addition, Geirite (TM) is not easily dissolved in water and the presence of insoluble materials is observed and cannot be easily isolated by simple filtration due to plugging of filtration material).

Imaging Science Journal, 2000, 48, p 193-198 discloses the sol-gel transition of a mixture of gelatin and K-carrageenan. The publication describes the gel formation from gelatin and carrageenan-K through rheology studies where gelatin is the main binder. The publication does not mention the combination of carrageenan and polyvinyl alcohol.

U.S. Pat. No. 6,419,987 discloses a method for providing a high viscosity coating on a moving web and articles made thereby through the use of an association of curing agents (boric acid and dihydroxy dioxane) and polyvinyl alcohol (PVA) for inkjet media application. The main drawbacks of the association of hardening compounds, that is DHD or borax, with polyvinyl alcohol are related to the cracking propensity and mottle coating defects encountered through the drying process required to manufacture inkjet receiver media. Furthermore, the hardening agents can induce side reactions resulting in yellowish stain as a function of the inkjet media ageing. These hardening agents can diffuse to the surface of the inkjet media and modifying the ink absorption properties by inducing trough curing reactions modifying the swelling and material porosity.

JP97104161 A discloses a recording transparent sheet utilizing xanthan gum on plastic sheet to produce recording media for inkjet application based on aqueous ink. JP97104162A discloses a recording transparent sheet utilizing xanthan gum on plastic sheet to produce recording media exhibiting two layers containing xanthan gum for inkjet application based on aqueous ink. Xanthan gum is well known as an efficient thickner but it does not provides gel formation. The main drawback of the Xanthan gum is related to the drastic viscosity boost that it induces, even at low content. Both patents do not mention any association with polyvinyl alcohol or guar gum. Furthermore, xanthan gum provides poor gloss and poor instant dryness property.

W02005/032837A1 relates to a recording medium comprising a support to which at least an underlayer and an overlayer is supplied in which the overlayer contains at least one type of modified gelatin and the isoelectric point (IEP) of the overlayer is different from the IEP of the underlayer. The use of gelatin with different IEP can improve some features, such as curl, but does not change the poor instant dryness of such material when used in an inkjet receiving layer.

W02005/016655A1 discloses a recording medium, comprising a support and an ink receiving layer which has an asymmetric membrane structure comprising a dense top layer adjacent to a microporous lower layer, said ink-receiving layer comprising at least one water-swellable polymer. The top layer is mainly constituted of gelatin material alone or in combination with polyvinyl alcohol, and cellulose derivatives. Such a top layer provides excellent gloss and ozone preservation but has a strong negative impact on the instant dryness and a higher propensity for ink coalescence and bleed phenomena, as a function of printer system, for diluted ink formula. The bottom layer is also differentiated based on the absence of polysaccharide material as binder.

W02004/110776A1 discloses that polyvinyl alcohol, cellulose and gelatin are the most common binders that have been used in inkjet media development. Both polyvinyl alcohol and cellulose do not provide very good image permanence. Gelatin does provide an excellent image permanence, but gelatin has severe curl problems at cold and dry conditions. The use of water-soluble polyvinyl acetal can provide not only the good light fastness and humid fastness on inkjet prints but also minimize the curl and stiffniess issues at cold and dry conditions. The inkjet receiving layer is formulated with polyvinyl acetate and gelatin as the binder system. This receiving layer system includes a low pigment content of 1 to 10% in weight. The gelatin is used as the main binder.

EP0875393B1 discloses inkjet recording media exhibiting low ink spreading property. An excellent sheet feeding property can be obtained by adding fine polysaccharide particles having a fine porous structure in an ink receiving layer. The polysaccharide material is based on calcium alginate. The alginate extracted from dried seaweeds is emulsified as an oil phase (n-hexane mixed with polyglycerine condensed recinoleic acid ester) and ionic cross-linking is performed by adding calcium chloride then porous calcium alginate particles are collected after washing and drying. The invention is based on “insoluble alginate particles” formed by adding calcium salt to soluble alginate. The main binder system is based on the use of polyvinyl alcohol, and polyvinyl pyrrolidone associated to co-binder (polyacrylic acid) or carboxymethyl cellulose. A chemical hardening agent is added. The present inventive system is differentiated by the use of soluble carrageenan compounds.

### PROBLEM TO BE SOLVED

There remains a need for a recording medium having good image printing quality based on excellent ink absorption speed, good drying characteristics, good light and ozone fastness, and gloss.

### SUMMARY OF THE INVENTION

The present invention relates to an ink receiving media comprising at least two receiving layers on a support, wherein the layer closest to the support comprises inorganic particles, polysaccharide in combination with guar gum and polyvinyl alcohol, and the layer farthest from the support comprises polysaccharide in combination with polyvinyl alcohol. The present invention also relates to an inkjet receiving media comprising at least two preferably thermoreversible receiving layers on a support, wherein the layer closest to the support comprises inorganic particles, carrageenan κ or carrageenan κ/ι in combination with guar gum and polyvinyl alcohol, and the layer farthest from the support comprises polymer materials based on carrageenan κ or carrageenan ι/ι in combination with polyvinyl alcohol.

### ADVANTAGEOUS EFFECT OF THE INVENTION

The present invention includes several advantages, not all of which are incorporated in a single embodiment. The present invention relates to a recording medium exhibiting at least two ink receiving layers, in particular an ink recording medium of photographic quality having a good image printing quality based on excellent ink absorption speed, good drying characteristics, good light and ozone fastness and gloss. The invention also provides multi-layered materials which exhibit good adhesion properties on polymeric web film support and avoids the use of crosslinker chemistry, such as borax, dihydroxy dioxane, or aldehyde.

### DETAILED DESCRIPTION OF THE INVENTION

The present invention is directed to an ink recording media, most preferably inkjet recording media, exhibiting photographic printing quality, which comprises a support, and at least one aqueous-based receiving lower layer containing inorganic pigment homogeneously dispersed in a polysaccharide system of carrageenan, guar gum, and polyvinyl alcohol and an aqueous-based upper layer containing the component polysaccharide and polyvinyl alcohol with a different content and ratio from the lower layer composition. This invention provides an ink recording media exhibiting high gloss level, excellent drying properties, and improved image stability properties, such as ozone and light keeping.

This invention relates to a multi-layer ink recording medium, having at least two hydrophilic layers, comprising at least one micro-porous lower layer containing a mixture of polymeric binder based on polysaccharide (mainly carrageenan), associated with a low content in guar gum, combined with polyvinyl alcohol, both hydrophilic polymers comprising hydroxyl groups, and one top layer mainly constituted by hydrophilic polymeric materials based on a combination of polysaccharide (mainly carrageenan) and polyvinyl alcohol (hydrophilic polymer comprising hydroxyl groups). For purposes of the present invention, the lower or bottom layer refers to the layer of the at least two receiving layers, which is closest to the support. For purposes of the present invention, the upper or top layer refers to the layer of the at least two receiving layers, which is farthest from the support. In both lower layer and upper layers, the polysaccharide content is adjusted to induce the formation of a gelled film just after the coating point, even for thick layer coating, for example, 200 μm to 400 μm wet thickness for the lower layer and 50 to 200 μm wet thickness for the upper layer.

The present inventive binder system, combining carrageenan/PVA/guar gum sublayer with a carrageenan/PVA top layer, does not require any curing agent. Some alginate materials, such as (ALGOGEL 3001 (TM) supplied by DEGUSSA, were evaluated and produced drawbacks, including colored solutions even at 0.7% in weight, and, when acidic pH is utilized to obtain thermoreversible gel formation, a turbid media is observed with high syneresis phenomena (67% liquid exhausted from gel part in volume).

The multi-layer ink recording medium, preferably for inkjet use, has at least one micro-porous lower layer containing a mixture of hydrophilic materials based on a polysaccharide, specifically carrageenan, associated with a low content in guar gum, combined with polyvinyl alcohol. Carrageenan is typically made from dried extracts of red seaweed (rhodophyceae). carrageenans are linear polysaccharides made up of more or less substituted galactose units. The chain is made up of subunits called carrabioses comprising two galactose units bound by a β (1-4) linkage. These carrabioses are bound together in the chain by α (1-3) linkages. Furthermore, the galactose units are either esterified by sulfuric acid, or have an oxygen bridge between carbons 3 and 6. Carrageenans are polymers made up of more than 1000 galactose residues (units). There are three main types of carrabiose: κ-carrabiose, ι-carrabiose, and λ-carrabiose, corresponding to the three main types of carrageenans: κ-carrageenan, a polysaccharide made up of n units of κ-carrabiose, ι-carrageenan, a polysaccharide made up of n units of ι-carrabiose, and λ-carrageenan, a polysaccharide made up of n units of λ-carrabiose.

According to the present invention, the carrageenan is selected from among the group comprising the κ-carrageenans, the ι-carrageenans or a combination of these compounds. Preferably, the carrageenan comprises at least 80% κ-carrageenan. According to an especially preferred variant, carrageenan is a pure κ-carrageenan. Carrageenan acts as a gelating agent enabling thermoreversible gelation of the composition intended to form the ink-receiving layer.

According to the invention, the ink-receiving layer comprises at least one polymer comprising hydroxyl groups. The polymer is most desirably water soluble and/or hydrophillic. Preferably, the polymer comprising the hydroxyl groups is selected from among the group including polyvinyl alcohol and guar gum, or a mixture of these polymers. The polymer comprising the hydroxyl groups enables the syneresis phenomena to be controlled to form a film as a gel without crystallization phenomena, even after the drying phase.

According to the invention, the composition intended to form the ink-receiving lower layer also comprises polyvinyl alcohol and guar gum. Polyvinyl alcohol is used as binder and guar gum is used as co-binder. Guar gum enables the phenomena of syneresis and the material's Theological characteristics to be controlled, and enables the viscosity of the composition intended to form the ink-receiving layer to be reduced. Guar gum is believed to control carrageenan helix aggregation. The guar gum is used in the range of from 1:20 to 1:5 of the carrageenan content and more preferably equal to 1/10 of the carrageenan weight content. Polyvinyl alcohol enables the gel strength to be increased, syneresis phenomena to be reduced in synergy with the guar gum, in order to obtain good mechanical properties such as adhesion and absence of crackle, and a gloss appearance. Preferably, polyvinyl alcohol has a molecular weight in the range of from 55,000 to 200,000 g/mole and more preferably greater than 90,000. The concentration of the polyvinyl alcohol can vary over a large range of from 0.5% to 5% in weight, more preferably, from 1 to 3% in weight content.

The inorganic particles utilized in the lower layer can be natural or synthesized compounds having a neutral surface charge (for example, calcium carbonate, barium sulfate) or a positive surface charge (for example, zinc oxide, alumina, zeolithe, molecular sieve, alumina/silica, modified silica). Preferably, the composition intended to form the ink-receiving layer comprises less than 40% by weight inorganic particles, and preferably between 13% and 33% by weight of inorganic particles in the wet composition. The inorganic particles, also referred to as fillers, may be porous.

The aqueous-based receiving lower layer contains inorganic material and a low hydrophilic gelator polymer content, that is, carrageenan κ, carrageenan κ/ι, or carrageenan ι in combination with guar gum and polyvinyl alcohol, of from 3 to 15% maximum in weight, and more preferably from 3 to 10%. The gelator content preferably ranges from 0.07 to 3% maximum weight %, more preferably from 0.15 to 2%, as a function of the inversed inorganic weight content, which varies from 33 to 13%. The weight ratio between hydroxylated polymers (polyvinyl alcohol, guar gum) and gelator preferably varies in the range of 2 to 40, more preferably 15 to 25. The layer may also contain inorganic particles in a preferred range of from 85 to 97% of the total weight.

This multi-layers ink recording medium also has one upper layer mainly constituted by hydrophilic polymeric materials based on a combination of polysaccharide, specifically, carrageenan, and polyvinyl alcohol. At least two interacting components are required to constitute the gelled thin film layer: first, a gelling agent, also referred to as a gelator, to promote the thermoreversible gel formation (carrageenan Kappa, Kappa/Iota, Iota) and, second, at least one hydroxylated polymers, such as polyvinyl alcohol. The gelator (for example, carrageenan compounds) content ranges from 15 to 80% maximum weight content, and, more preferably, from 25 to 70%. The aqueous-based upper layer contains a total weight content of from 3 to 80% maximum in weight content of hydrophilic polymers, more preferably a total weight content of from 7 to 68%. A second hydroxylated polymer, used as third component, can be associated with the previous two main components system (carrageenan—polyvinyl alcohol).

The lower and upper layers according to the invention may contain other additives, such as surfactants, most preferably a fluorinated surfactant. The fluorinated surfactant is preferably in the range of from 5-25% by weight. Other materials for creating imaging or receiving layers may also be present.

The coating thickness is typically in the range of from 10 to 50 μm (dried thickness) and preferably about 25 μm. The weight content ratio of carrageenan κ or carrageenan κ/ι between the layer farthest from the support and the layer closest to the support is in the range 2/20 and more preferably 7/14. The weight content ratio of polyvinyl alcohol between the layer farthest from the support and the layer closest to the support is in the range of from 1/10 and more preferably 1/5. The upper layer is thinner than the lower layer.

In one embodiment of the invention, the first component is a carrageenan compound exhibiting a high Kappa fraction in combination with, as a second component, a polyvinyl alcohol to constitute upper layer coated onto micro-porous lower layer as inkjet receiving layer. The combination of a carrageenan compound exhibiting a high Kappa fraction with a polyvinyl alcohol has been found advantageous for use in an inkjet media top layer to promote high gloss level, high printed density and good image preservation. In another embodiment of the invention, image stability properties are drastically increased using upper layer based on the combination of carragheenan in combination with a polyvinyl alcohol.

Any support or substrate may be used in a recording element (plain or calendered paper, resin coated paper, coated paper with polyol layers, polymeric films such as polyesters (PET, PEN). The coating process could be performed in one or two steps.

A large number of organic polymer (PVA, sulfonic polymer) or inorganic material are able to provide glossy features for inkjet media when they are used in the top layer. Nevertheless, these materials drastically modify the receiving properties, especially in terms of instant dryness. The preliminary experiments utilizing the present invention, made on a hand coater, demonstrated drastic gloss improvement compared to the same lower layer made without an upper layer. The instant dryness is fully preserved. The technology can be extended to a large number of inorganic receiving layers, but can be also applied to organic or hybrid media.

The preliminary screening experiments also demonstrated that the gloss benefit resulted from the combination carrageenan and PVA. One role of the lower layer is to absorb ink. The lower layer is typically at least 25 μm layer thickness in the dried state. The role of the top layer is to promote gloss without any penalty in terms of ink absorption, that is, maintaining instant dryness, and improvement in terms of image preservation. The replacement of PVA by guar gum did not change the lower layer gloss. The replacement of carrageenan by xanthan gum did not alter the low gloss level of the porous lower layer. The invention provides a glossy appearance, even though the receiving layer exhibits low gloss characteristics. The gloss improvement was not a function of the upper layer thickness. From preliminary experiments, a polysaccharide/PVA upper layer having a 50 μm wet thickness was sufficient to obtain good gloss levels, for example, a 50-54 gloss value measured at 60° in place of a gloss value of 23.

The change in the setting properties can be controlled by varying the concentration in carrageenan, by using carrageenan with lower content in Kappa (κ) fraction or by mixing carrageenan exhibiting different Kappa fraction and varying the level of the second component.

The invention provides multi-layered materials that exhibit good adhesion properties on polymeric web film support and avoids the use of crosslinker chemistry, for example borax, dihydroxy dioxane, aldehyde.

The change in the setting properties for both lower and upper layers can be controlled by varying the concentration in carrageenan, by using carrageenan with lower content in Kappa fraction or by mixing carrageenan exhibiting different Kappa fractions and varying the level of the second component. Even at the lowest level content of the polymeric materials, a gelled film is formed just after the coating point on web the support, even for thick layers (200 μm).

The following examples are provided to illustrate the invention. In all examples, all components used in inkjet melt formula are expressed in weight percentage unless otherwise specified.

Impact of Carrageenan Type:

The main types of carrageenan are differentiated as a function of the sulphate group substituting the galactose unit: the function Kappa exhibits 1 sulphate for 2 galactose units, the function Iota exhibits 1 sulphate per galactose unit, and the function Lambda exhibits 3 sulphates for 2 galactose units. The carrageenan Kappa and Iota are able to provide gel. Carrageenan Lambda is considered as a thickener. Carrageenan Lambda was discarded from this application based on the inability to obtain hydrogel formation.

The experiments were pursued using carrageenan Kappa, Iota and mixture Kappa/Iota. The samples were supplied by Degussa Texturant Systems (France). All compounds were used without any purification treatment. The various salts content are indicated in Table A (information provided by Degussa Texturant Systems) for carrageenan exhibiting a high Kappa fraction.

TABLE A
Salts content in carrageenans

| | Compounds | | |
|---|---|---|---|
| | Na⁺ | K⁺ | Ca²⁺ |
| ME-5 | 1.4 | 14.4 | 0.1 |
| AMP-45 | 1 | 7 | 0.4 |
| SIA | — | — | — |

Salts content: expressed in g/100 g of considered carrageenan compound.

The carrageenans Kappa and Iota cannot be supplied as pure compounds. Generally, their extracts contain a large majority fraction of the considered form (A. Parker et Al., Carbohydrate Polymers, 20 (1993), 253-62). The Iota fraction was determined using IR spectroscopy and measurements were performed at 805 cm⁻¹ (pronounced band attributed to 3,6-anhydro-D-galactose 2-sulfate) (D. A. Rees, Advances in Carbohydrate Chemistry (1969), 24 267-332.). The calibration was carried out on powder samples by mixing both pure Kappa (ME5) and pure Iota (SIA). The Iota weight ratio varied from 0 to 20% maximum. The calibration measurements are reported in Table B.

TABLE B
Determination Kappa/Iota ratio in carrageenans

| | Kappa | Kappa | Iota | Iota |
|---|---|---|---|---|
| Carrageenan type weight ratio | (calib) | (pred) | (calib) | (pred) |
| SIA (Iota) | 0 | −0.30 | 100 | 100.30 |
| ME5 (Kappa) | 100 | 99.32 | 0 | 0.68 |
| ME5 80 (Kappa)/SIA 20 (Iota) | 80 | 82.00 | 20 | 18.00 |
| ME5 90 (Kappa)/SIA 10 (Iota) | 90 | 90.20 | 10 | 9.80 |
| ME5 95 (Kappa)/SIA 5 (Iota) | 95 | 93.78 | 5 | 6.22 |
| AMP 45 (Kappa/Iota) | | 94.86 | | 5.14 |

By this way, the Iota content in the AMP45 and in ME5 sample was determined. Other compounds supplied by Degussa Texturant systems were guar gum (Viscogum BCR 13/80) and Xanthan gum (Satiaxane CX90) compounds. Guar gum is well known to interact with carrageenans (κ and ι fraction) to promote helix aggregation and control syneresis phenomena.

Potassium content & Carrageenan Iota:

To boost the gelling power of Kappa/Iota carrageenan, the addition of potassium ion is recommended, based on the ability of potassium to diffuse into the helix to counterbalance the negative charge of the sulfate group and to induce helix aggregation to promote higher gel formation. Generally, the potassium salt content corresponds to 1/10^{th} of the carrageenan content in weight. Nevertheless, the addition of potassium salt (chloride form) does not impact the printing properties or image fastness (light and ozone).

### EXAMPLE 1

### Study of Gel Formation from Pure Polysaccharides or Mixture with PVA

Screening on polysaccharides was done using the recommended level from publication literature or supplier recommendations. In Table 1, the formation of gelled material and gel characteristics are summarized for polysaccharides compounds or polysaccharides compounds in association with PVA material (Aldrich Cemical supplier, MW=85,000-146,000, 87-89% hydrolyzed). All materials were dissolved in hot distilled water (80° C). For the various materials family, the main results are reported in Table 1 in terms of solution characteristics and gel features for polysaccharides with or without polyvinyl alcohol.

For polysaccharide alone, the gel formation in the studied concentration range was only observed for Kappa carrageenan (Satiagel AMP45, Satiagel ME5). The presence of polyvinyl alcohol reduces or eliminates the syneresis phenomena observed with the pure carrageenan solution. The turbidity of the polysaccharide solution should be reduced in the presence of the polyvinyl alcohol (Satiagel AMP45). For some polysaccharides material, demixing phenomena was recorded in the presence of polyvinyl alcohol (Sclerogucan, guar gum).

To conclude, the most efficient compounds to achieve gel formation are carrageenans exhibiting high Kappa fraction and their combination with polyvinyl alcohol which were observed to control syneresis phenomena.

TABLE 1
Characteristics of polysaccharide solution and gel features

| Polysaccharide | Polysaccharides | PVA | pH | Gel | Solution | Gel |
|---|---|---|---|---|---|---|
| Type | system | at 3% | at 40° C. | formation | characteristics | features |
| Carrageenans | Satiagel AMP 45 | No | 8.34 | Yes | Medium turbidity | Low syneresis |
| | (0.70%) | | | | Yellowish color | soft gel |
| | | Yes | 7.27 | Yes | Low turbidity | No syneresis |
| | | | | | | soft gel |
| | Satiagel ME 5 | No | 8.37 | Yes | Low turbidity | Low syneresis |
| | (0.70%) | | | | whitish color | soft gel |
| | | Yes | 6.21 | Yes | Low turbidity | No syneresis |
| | | | | | whitish color | soft gel |
| Xanthan | Satiaxane CX 90 | No | 6.33 | No | High turbidity | — |
| gum | (0.70%) | Yes | 5.70 | No | High turbidity | — |
| | | | | | high viscosity | |
| Alginate | Algogel 3001 | No | 7.71 | No | Transparency | — |
| | (0.70%) | | | | slight brownish color | |
| | | Yes | 6.90 | No | Transparency | — |
| | | | | | slight brownish color | |
| Scleroglucan | Actigum CS 11 | No | 6.18 | No | Medium turbidity | — |
| | (0.70%) | Yes | — | ? | Biphasique system | — |
| Guar gum | Viscogum BCR 13/80 | No | 6.51 | No | Low turbidity | — |
| | (0.70%) | Yes | — | ? | Biphasique system | — |
| gellan gum | Gelrite | No | 6.13 | No | Residue | — |
| | (0.50%) | Yes | 6.02 | No | Residue | — |

### EXAMPLE 2

### Study of Gel Formation from Polysaccharides Mixture with or without Polyvinyl Alcohol.

Screening on polysaccharides was done using recommended level from publication literature or supplier recommendations. In Table 2, the formation of gelled material and gel characteristics are summarized for 30 polysaccharides compounds or in association with PVA material (Aldrich supplier, MW=85,000-146,000, 87-89% hydrolyzed). All materials were dissolved in hot distilled water (80° C). For the various materials family, the main results are reported in Table 1 in terms of solution characteristics and gel features for polysaccharides with or without polyvinyl alcohol.

For carrageenan mixture in combination with guar gum, the gel formation was improved and syneresis phenomena was reduced or fully eliminated (in the absence of polyvinyl alcohol). Furthermore for carrageenan exhibiting a high Kappa fraction (Satiagel ME5, Satiagel AMP45), demixing phenomena was observed in the presence of polyvinyl alcohol, even at low concentration for guar gum (0.07%). Similar results were observed for xanthan gum, where demixing phenomena is occurring when polyvinyl alcohol is added in the polysaccharides mixture.

Unlike systems based on alginate, the gel formation was induced under acidic conditions but the syneresis phenomena was drastically increased compared with the carrageenan system and the addition of the polyvinyl alcohol

To conclude, the gel formation was improved for carrageenan exhibiting high Kappa fraction when they were mixed with guar gum even at low content level ( 1/10 of carrageenan content). For carrageenan/guar gum mixture, the addition of polyvinyl alcohol induced demixing phenomena even at low guar gum content. Xanthan gum in combination with guar gum also provided gelled materials with interesting features (flexible and soft gel). Gelrite (TM) provided gelled material exhibiting no syneresis phenomena but the gelled material was too sensitive to shear stress (soft and brittle gel). Alginate (TM) was excluded based on residual gel coloration.

TABLE 2
Characteristics of solution and gel features from polysaccharides
mixtures with/without polyvinyl alcohol.

| Polysaccharide | | | pH at | Gel | | |
|---|---|---|---|---|---|---|
| type | Polysaccharide system | PVA at 3% | 40° C. | formation | Solution characteristics | Gel characteristics |
| Carrageenans + | Satiagel AMP 45 (0.70%) + KCl | No | 8.08 | Yes | Low turbidity Yellowish | Low syneresis soft |
| addenda | (0.07%) | | | | color | gel |
| | | Yes | 6.99 | Yes | Low turbidity Yellowish | No syneresis soft gel |
| | | | | | color | |
| | Viscogum BCR 13/80 (0.70%) + Satiagel | No | 8.85 | Yes | Turbide light yellowish | No syneresis soft gel |
| | AMP 45 (0.70%) | | | | color | |
| | | Yes | — | ? | Biphasique system | — |
| | Viscogum BCR 13/80 (0.07%) + Satiagel | No | 9.48 | Yes | Low turbidity light | Low syneresis soft |
| | AMP 45 (0.70%) | | | | yellowish color | gel |
| | | Yes | — | ? | Biphasique system | — |
| | Viscogum BCR 13/80 (0.70%) + Satiagel | No | 8.51 | Yes | Turbide light yellowish | No syneresis elastic |
| | AMP 45 (0.70%) + KCl | | | | color | gel |
| | (0.07%) | Yes | — | ? | Biphasique system | — |
| | Viscogum BCR 13/80 (0.07%) + Satiagel | No | 9.15 | Yes | Low turbidity light | No syneresis soft gel |
| | AMP 45 (0.70%) + KCl | | | | yellowish color | |
| | (0.07%) | Yes | — | ? | Biphasique system | — |
| | Viscogum BCR 13/80 (0.70%) + Satiagel | No | — | Yes | Turbide light whitish color | No syneresis elastic |
| | ME 5 (0.70%) | | | | | gel |
| | | Yes | — | ? | — | — |
| | Viscogum BCR 13/80 (0.07%) + Satiagel | No | 7.90 | Yes | Low turbidity whitish color | Low syneresis soft |
| | ME 5 (0.70%) | | | | | gel |
| | | Yes | — | ? | Biphasique system | — |
| Xanthan + | Viscogum BCR 13/80 (0.35%) + Satiaxane | No | — | Yes | High turbidity whitish color | Low syneresis soft |
| addenda | CX 90 (0.35%) | | | | | gel |
| | | Yes | — | ? | Biphasique system | — |
| | Viscogum BCR 13/80 (0.60%) + Satiaxane | No | — | Yes | Low turbidity whitish color | No syneresis flexible |
| | CX 90 (0.10%) | | | | | and soft gel |
| | | Yes | — | ? | Biphasique system | — |

### EXAMPLE 3

### Comparison of Polysaccharides Systems

The printing performance of the polysaccharide systems were evaluated for a coating series done on resin coated (RC) paper (RC paper support treated by corona effect and having gel lower layer).

The coating experiments were carried out on automatized equipment using the following conditions:

Speed coating=0.3m.s⁻¹

Setting temperature=10° C.

Wet film thickness=200 μm

Solution temperature=50° C.

Coating temperature=45° C.

The printing performances were evaluated using two printer systems: HP Deskjet 5550, and EPSON Stylus Photo890. The printing performance was analyzed in terms of the print features, for example, gloss aspect, and ink difflusion, for both printing systems. Furthermore, the ink drying fastness was determined by using a transfer method: immediately after printing the printed receiving layer was put into a contact with a receiving paper sheet, the package was submitted to pressure between two rollers, and the transfer print was evaluated (the transfer experiment could be repeated at 1 min. delay to have an idea about the drying kinetic).

The xanthan system did not provide good ink drying fastness and provided poor gloss. The carrageenan materials provided faster ink drying systems even with diluted ink formula (EPSON) without any ink spreading (carrageenan combined with guar gum).

Preparation of the Mother Solutions

All the solutions were prepared using deionized water. The polyvinyl alcohol was supplied by Gohsenol as GH23 (hydrolysis rate 87-89%). The concentrations of all solutions required are reported in Table 3. Each solution was prepared using similar operating conditions: each compound is added into the required water volume at room temperature under magnetic stirring, avoiding vortex formation. After 1 hour, the mixture was heated at 80° C. until complete material dissolution. After dissolution, the solution was cooled at room and water was added to overcome evaporation. All polysaccharides solutions were stored at 8° C. to avoid biogrowth.

TABLE 3
Content of the various mother solutions

| | PVA | | | | | |
|---|---|---|---|---|---|---|
| Compounds | GH 23 | ME5 | AMP45 | CX90 | SIA | Viscogum |
| GH 23 (g) | 180 | 0 | 0 | 0 | 0 | 0 |
| ME5 (g) | 0 | 30 | 0 | 0 | 0 | 0 |
| AMP45 (g) | 0 | 0 | 30 | 0 | 0 | 0 |
| SIA (g) | 0 | 0 | 0 | 0 | 30 | 0 |
| CX90 (g) | 0 | 0 | 0 | 30 | 0 | 0 |
| Viscogum | 0 | 0 | 0 | 0 | 0 | 2 |
| (g) | | | | | | |
| Water | 1820 | 970 | 970 | 990 | 970 | 198 |
| QSP | 2000 | 1000 | 1000 | 1000 | 1000 | 200 |
| % solid | 9.00% | 3.00% | 3.00% | 3.00% | 3.00% | 1.00% |

Prepartion of the Polysaccharides Inkjet Melts

The comparison of the various polysaccharides systems was carried out for combinations of carrageenan/guar gum and carrageenan/PVA or xanthan/guar gum.

ME5/Viscogum (3A)

23.5 g of Satiagel ME5 solution (3% content) was added in 68 ml of deionized water under magnetic stirring and heated at 60° C. The required amount of viscogum (7 g, 1% solution content) was added and mixture was stirred for 15 min. To improve coating homogeneity, 10 G surfactant (1.5 g, 20% solution content) was introduced under smooth stirring to avoid foam formation. The mixture was cooled at room temperature and the required amount of deionized water was added to obtain 100 g of mixture.

ME5/PVA (3B)

23.5 g of Satiagel ME5 solution (3% content) was added in 59 ml of deionized water under magnetic stirring and heated at 60° C. The required amount of PVA (16.5 g, 9% solution content) was added and mixture was stirred for 30 min. To improve coating homogeneity, 10 G surfactant (1.5 g, 20% solution content) was introduced under smooth stirring to avoid foam formation. The mixture was cooled at room temperature and the required amount of deionized water was added to obtain 100 g of mixture.

AMP45/Viscogum (3C)

23.5 g of Satiagel AMP45 solution (3% content) was added in 62 ml of deionized water under magnetic stirring and heated at 60° C. The required amount of viscogum (7 g, 1% solution content) was added and mixture was stirred for 15 min. After, potassium chloride solution was added (7 g, 1% solution content). To improve coating homogeneity, 10 G surfactant (1.5 g, 20% solution content) was introduced under smooth stirring to avoid foam formation. The mixture was cooled at room temperature and the required amount of deionized water was added to obtain 100 g of mixture.

AMP45/PVA (3D)

23.5 g of Satiagel AMP45 solution (3% content) was added in 51 ml deionized water under magnetic stirring and heated at 60° C. The required amount of PVA (16.5 g, 9% solution content) was added and mixture was stirred for 30 min. After, potassium chloride solution was added (7 g, 1% solution content). To improve coating homogeneity, 10 G surfactant (1.5 g, 20% solution content) was introduced under smooth stirring to avoid foam formation. The mixture was cooled at room temperature and the required amount of deionized water was added to obtain 100 g of mixture.

SIA/Viscogum (3E)

23.5 g of Satiagel SIA solution (3% content) was added in 68 ml of deionized water under magnetic stirring and heated at 60° C. The required amount of viscogum (7 g, 1% solution content) was added and mixture was stirred for 15 min. To improve coating homogeneity, 10 G surfactant (1.5 g, 20% solution content) was introduced under smooth stirring to avoid foam formation. The mixture was cooled at room temperature and the required amount of deionized water was added to obtain 100 g of mixture.

SIA/PVA (3F)

23.5 g of Satiagel SIA solution (3% content) was added in 58 ml of deionized water under magnetic stirring and heated at 60° C. The required amount of PVA (16.5 g, 9% solution content) was added and mixture was stirred for 30 min. To improve coating homogeneity, 10 G surfactant (1.5 g, 20% solution content) was introduced under smooth stirring to avoid foam formation. The mixture was cooled at room temperature and the required amount of deionized water was added to obtain 100 g of mixture.

CX90/Viscogum (1:1 weight ratio) (3G)

11.75 g of Satiaxane CX90 solution (3% content) was added in 52 ml of deionized water under magnetic stirring and heated at 60° C. The required amount of viscogum (35 g, 1% solution content) was added and mixture was stirred for 15 min. To improve coating homogeneity, 10 G surfactant (1.5 g, 20% solution content) was introduced under smooth stirring to avoid foam formation. The mixture was cooled at room temperature and the required amount of deionized water was added to obtain 100 g of mixture.

CX90/Viscogum (1:6) (3H)

3.5 g of Satiaxane CX90 solution (3% content) was added in 35 ml of deionized water under magnetic stirring and heated at 60° C. The required amount of viscogum (60 g, 1% solution content) was added and mixture was stirred for 15 min. To improve coating homogeneity, 10 G surfactant (1.5 g, 20% solution content) was introduced under smooth stirring to avoid foam formation. The mixture was cooled at room temperature and the required amount of deionized water was added to obtain 100 g of mixture.

Prepartion of Check Inkjet Melts

The previous polysaccharides systems were compared with PVA systems (with and without curing agents) or in combination with viscogum.

PVA (3I)

33.33 g of PVA solution (9% solution content in GH23) was added in 65 ml of deionized water under magnetic stirring and heated at 60° C. To improve coating homogeneity, 10 G surfactant (1.5 g, 20% solution content) was introduced under smooth stirring to avoid foam formation. The mixture was cooled at room temperature and the required amount of deionized water was added to obtain 100 g of mixture.

PVA/Boric acid+DHD (3J)

33.33 g of PVA solution (9% solution content in GH23) was added in 65 ml of deionized water under magnetic stirring and heated at 60° C. The 1-4 dioxane-2,3 diol (180 mg, supplied by Aldrich, reference=25,624-2, 98% purity) and boric acid (50 mg, supplied by Aldrich, reference=33,906-7, 99,99% purity) were added under an efficient stirring. To improve coating homogeneity, 10 G surfactant (1.5 g, 20% solution content) was introduced under smooth stirring to avoid foam formation. The mixture was cooled at room temperature and the required amount of deionized water was added to obtain 100 g of mixture.

Viscogum (3K)

70 g of viscogum (1% content) was added in 29 ml of deionized water under magnetic stirring and heated at 60° C. To improve coating homogeneity, 10 G surfactant (1.5 g, 20% solution content) was introduced under smooth stirring to avoid foam formation. The mixture was cooled at room temperature and the required amount of deionized water was added to obtain 100 g of mixture.

Viscogum/PVA (3L)

70 g of viscogum solution (1% content) was added in 29 ml of deionized water under magnetic stirring and heated at 60° C. The required amount of PVA GH23 (16.5 g, 9% solution content) was added and mixture was stirred for 15 min. To improve coating homogeneity, 10 G surfactant (1.5 g, 20% solution content) was introduced under smooth stirring to avoid foam formation. The mixture was cooled at room temperature and the required amount of deionized water was added to obtain 100 g of mixture.

Coating of the Inkjet Melts

All inkjet melts were coated using hand coater for a theoretical wet thickness about 200 μm on resin coated paper having gel lower layer coated with about 30 mg/ft2 of gelatin applied using corona treatment in line. The operating conditions are summarized in Table 4.

TABLE 4
Operating conditions for hand-coater

| Parameters | Values | |
|---|---|---|
| Coating speed | 0.3 | ms⁻¹ |
| Wet thickness | 200 | μm |
| Coated surface area | 630 | cm² |
| Web temperature | 15° | C. |
| Coated solution volume | 20 | ml |
| Melt solution temperature | 60° | C. |

The solution and coating features for all experiments are reported in Table 5. The viscosity measurements were carried out at 60° C. (L2 spindle, with 100-200 rpm shear rate) using Visco Star-L equipment supplied by Fungilab S.A. The determination of gloss from coated samples was measured using Picogloss model 560 equipment from Erichsen Testing Equipment.

All polysaccharides systems in combination with guar gum or PVA exhibited high coatability with good homogeneity and good mechanical properties (good adhesion to support, no cracks propensity). The good coating homogeneity can be directly connected to the ability to easily achieve gel formation for all polysaccharides systems (based on combination with PVA or guar gum). A film former, such as polyvinyl alcohol, exhibited no chill setting property and was unable to provide, by itself, a homogeneous coating thickness and showed some sensitivity to abrasion. The combination between polyvinyl alcohol and chemical curing agent produced increased coating homogeneity but without real gel formation. Furthermore, such systems based on PVA/curing agent exhibited poor coating robustness due to the rheology changes as a function of the material ageing.

Guar gum used alone was acting as a thickener providing homogeneous coating with good mechanical properties. The association of polyvinyl alcohol with guar gum provided unstable solution when the mixture was cooled at room temperature: a fast demixing phenomena was observed with an upper transparent phase (PVA) and an opalescent bottom phase (guar gum).

With respect to film gloss features, polyvinyl alcohol provided the higher gloss level. For carrageenans compounds, the higher gloss level was achieved by combination with polyvinyl alcohol (lower level obtained by combination with guar gum). The Iota fraction produced the higher gloss level.

The use of polyvinyl alcohol alone did not provide very homogeneous coating even by keeping the coated sample until a fully dried state was achieved and this state can only be achieved for hand-coating equipment due to inability to obtain coating on a coating machine using vertical loop dryer.

Evaluation of the Printing, Properties

The printing properties were analyzed from printed chart tests for two inkjet printers HP Deskjet 5550 and EPSON stylus Photo 890. The printing properties were evaluated for image sharpness (ink: coalescence, spray and bleed; banding, bronzing), instant dryness and abrasion sensitivity. All printing features of the coating set are reported in Table 6.

Instant dryness (Inst.Dryn.): The test was done from printed test charts just after printing. A paper receiving sheet (A4 format, 80 g quality) was directly put onto the printed sheet and a roller (weight=2 kg, L=18.5 cm, φ=4.0 cm) was applied and the level of dye report onto the receiving sheet was qualitatively appreciated (1=no report, 2=light colored marks unability to detect pictures elements, 3=at least two identified colors and partially pictures elements, 4=at least 3 colors identified and 60-70% elements scenes reproduced on the receiving sheet, 5=all colors identified and at least 80% elements scene reproduced on the receiving sheet).

Sharpness: Image sharpness was expressed from three levels (High=perfect elements scene reproduction, medium=slight image degradation based on bleed phenomena (low to medium magnitude) or coalescence (Low to high), Low=high image degradation due to muddy colors (high bleed phenomena, high spray phenomena).

Defect: Recorded image degradation phenomena (A=abrasion induced by printer under marks phenomena or partial delamination, Ba=banding inducing distinct differences of pattern instead of smooth colors transition, Bl=Bleed corresponding to ink spreading, C=ink coalescence) with three magnitude levels (High, Medium, Low)

Finger sensitivity: 1 hour after printing, the media sensitivity to fingers mark was evaluated by simple observation under oblique light exposure.

The experimental series demonstrates that only carrageenan Kappa or Kappa/Iota or Iota in combination with hydroxylated polymers was able to provide inkjet media with high/medium image sharpness as a function of the printer type, good instant dryness characteristic (notably for association with polyvinyl alcohol). Furthermore, polysaccharides associated with hydroxylated polymers provided good mechanical properties: high adhesion onto resin coated paper, no cracking propensity, and no curl sensitivity.

TABLE 5
Solution & coating features from inkjet melts

| | | | Viscosity | | Gloss |
|---|---|---|---|---|---|
| Polysaccharide | Co-binder | Solution/Gel | (mPa · s⁻¹) | Coating features | (60°) |
| ME5 | Viscogum (3A) | Homogeneous & | 10 | Homogeneous coating, | 26 |
| | | opalescent, strong gel, | | fast setting property, | |
| | | 3% syneresis | | good adhesion | |
| | PVA (3B) | Homogeneous & | 17 | Homogeneous coating, | 32 |
| | | transparentent, strong | | fast setting property, | |
| | | gel, 2% syneresis | | good adhesion | |
| AMP45 | Viscogum (3C) | Homogeneous & | 17 | Homogeneous coating, | 30 |
| | | opalescent, strong gel, | | fast setting property, | |
| | | 3% syneresis | | good adhesion | |
| | PVA (3D) | Homogeneous & | 30 | Homogeneous coating, | 40 |
| | | transparent, strong gel, | | fast setting property, | |
| | | 1% syneresis | | good adhesion | |
| SIA | Viscogum (3E) | Homogeneous & | 31 | Homogeneous coating, | 35 |
| | | transparent, soft gel | | fast setting property, | |
| | | | | good adhesion | |
| | PVA (3F) | Homogeneous & | 39 | Homogeneous coating, | 55 |
| | | transparent, soft gel | | fast setting property, | |
| | | | | good adhesion | |
| Xanthan | Viscogum | Homogeneous & | 36 | Homogeneous coating, | 29 |
| | (1:1) (3G) | opalescent, very soft | | fast setting property, | |
| | | gel | | good adhesion | |
| | Viscogum | Homogeneous & | 34 | Homogeneous coating, | 60 |
| | (1:6) (3H) | opalescent, very soft | | fast setting property, | |
| | | gel | | good adhesion | |
| PVA | 0 (3I) | Homogeneous | 6.6 | Unhomogeneous | 88 |
| | | tranparent solution | | coating thickness, | |
| | | | | abrasion sensitivity | |
| | DHD + Boric | Homogeneous | 5.5 | Homogeneous coating, | 90 |
| | ac. (3J) | tranparent solution | | unsetting, good | |
| | | | | adhesion | |
| Viscogum | 0 (3K) | Homogeneous | 40 | Homogeneous coating, | 55 |
| | | | | unsetting, good | |
| | | | | adhesion | |
| | PVA (3L) | Demixing, transparent | 13 | Homogeneous coating, | 55 |
| | | top phase, bottom | | unsetting, poor | |
| | | opalescent phase | | adhesion, cracked | |
| | | | | surface | |

TABLE 6
Printing properties of polysaccharides systems

| | | Printing properties | | | | | | | |
|---|---|---|---|---|---|---|---|---|---|
| | | HP 5550 | | | | [symbol] | | | |
| Binder systems | | Inst. | Imag. | | | Inst. | Imag. | | Fing. |
| Polysaccharide | Co-binder | Dryn. | ISharp. | Defect | Fing.sens | Dryn. | Sharp. | Defect | sens. |
| ME5 | Viscogum (3A) | 3 | Medium | C(L) | No | 5 | Low | S(H), Bl(H) | No |
| | PVA (3B) | 1 | High | No | No | 2 | Medium | C(H), Ba(H) | No |
| AMP45 | Viscogum (3C) | 2 | High | No | No | 4 | Low | C(H), Bl(H) | No |
| | PVA (3D) | 1 | High | No | No | 2 | Medium | C(H), Ba(H) | No |
| SIA | Viscogum (3E) | 5 | Medium | C(M), | No | 5 | Low | S(H), Bl(H), | No |
| | | | | Bl(M) | | | | Ba(H) | |
| | PVA (3F) | 3 | High | No | No | 3 | Medium | C(H), Ba(H) | No |
| Xanthan | Viscogum (1:1) | 4 | High | Bl(L) | No | 5 | Low | S(H), Bl(H), | No |
| | (3G) | | | | | | | Ba(L) | |
| | Viscogum (1:6) | 4 | Medium | C(L), | No | 5 | Low | S(H), Bl(H), | No |
| | (3H) | | | Bl(L) | | | | Ba(L) | |
| PVA | 1.50% (3I) | 5 | High | No | Yes | 5 | Low | C(L), Bl(H), | Yes |
| | | | | | | | | S(H), Ba(L) | |
| | 3% (3J) | 3 | High | No | Yes | 5 | Medium | C(H), | Yes |
| | | | | | | | | Bl(H), Ba(H), | |
| | | | | | | | | A(M) | |
| | DHD + Boric ac. | 3 | Low | C(H), | Yes | 5 | Low | C(H) S(H) | Yes |
| | (3K) | | | Ba(H) | | | | Ba(H) | |
| Viscogum | 0 (3L) | 5 | Medium | C(M) | Yes | 5 | Low | C(H) Bl(H) | Yes |
| | | | | A(M) | | | | S(H) Ba(H) | |
| | | | | Bl(L) | | | | | |
| | PVA (3M) | 2 | High | Bl(L) | No | 4 | Low | Bl(H) Ba(H) | No |
| | | | | A(H) | | | | A(H) | |
| Rc Paper | 0 | 5 | No | C(H), | Yes | 5 | No image | Bl(H), S(H), | Yes |
| | | | image | Bl(H) | | | | C(H) | |

### EXAMPLE 4

### Preparation Lower Layer Containing Pural/ME5/Viscogum/PVA)

Melt Preparation

For high inorganic content, the level of gelator might be optimized in order to reduce viscosity to improve melt delivery on the hopper system and coating quality. Carrageenan Kappa provided the higher gel strength, resulting in the ability to reduce its content in the inkjet melt to achieve the best compromise in terms of gel formation versus melt viscosity. Carrageenan compounds and guar gum (viscogum BCR 13/80) were supplied by Degussa Texturant Systems and used without any purification step. Carrageenan Kappa compounds was supplied as Satiagel ME5. The carrageenan compound was used as aqueous solution at 1% in weight: the solution was prepared by mixing the carrageenan powder into hot deionized water (heated at 80° C.) under vigourous stirring.

Equivalent experimental conditions were applied to prepare viscogum aqueous solution at 1% in weight. Pural 200 was dispersed in deionized water under magnetic stirring at room temperature. Then, the mixture was heated at 80° C. with constant mixing. At the same time, ME5 in the liquid solution state was added to the mixture with the viscogum BCR 13/80 before the addition of this mixture to Pural 200 aqueous dispersion under an efficient stirring. Polyvinyl alcohol was supplied by Nippon Goshei as Gohsenol GH23 and used under 9% PVA in weight aqueous solution. Polyvinyl alcohol was introduced at 80° C. under an efficient stirring. The mixture was cooled at 50° C. and the stirring level was reduced to introduce the surfactant 10 G. To compensate for water evaporation, deionized water was added to obtain 100 g of mixture. In order to achieve a good melt homogeneity, the mixture was stirred with an efficient homogenizer at 8000 rpm at 50° C. during 30 minutes. The weight concentrations are reported in Table 7.

TABLE 7
% in weight content on check melt

| | | | active wt. | |
|---|---|---|---|---|
| Components | Weight (g) | % content* | (gms) | % of solids |
| Pural 200 | 32.90 | 100.00 | 32.900 | 96.61 |
| ME5 (gel 1%) | 5.01 | 1.00 | 0.050 | 0.15 |
| viscogum (gel 1%) | 0.50 | 1.00 | 0.005 | 0.015 |
| GH-23 (sol 9%) | 6.67 | 9.00 | 0.600 | 1.76 |
| 10G | 2.50 | 20.00 | 0.500 | 1.468 |
| g solids | 34.06 | | 34.055 | 100.00 |
| Water (g) | 52.43 | | | |
| total wt. | 100.01 | | | |

Coating on Machine with RC Paper for Ink Receiving Layer

The aged inkjet melt from example 4 was coated on a coating 5 machine on resin coated paper (coated with about 30 mg/ft² of gelatin applied using corona treatment in line). The coating parameters are reported in Table 8 using bead coater equipment with a classical loop dryer.

TABLE 8
Coating parameters used on coating machine

| Parameters | Values | |
|---|---|---|
| Hopper gap | 200 | μm |
| Coating speed | 7 | m/min |
| Melt temperature | 50° | C. |
| Web temperature | 50° | C. |
| Chill setting temperature | 4° | C. |
| Coated width | 0.105 | m |
| Wet coverage | 117 | ml/m² |

Using these experimental conditions, good coating quality was achieved and characteristics of the coated ink receiving media are reported in Table 9.

TABLE 9
Characteristics of coated ink receiving lower layer

| Parameters | Values/Responses |
|---|---|
| Coating film quality | No coating defect observed (breakline), Small |
| | crack propensity observed |
| | Strong adhesion onto RC paper |
| Dried film thickness | 25 μm |
| Film surface aspect | Good surface homogeneity, |
| Gloss (60° measurement) | 22 |

The coating film quality was primarily controlled through visual observation from coated media sample. The visual examination was completed by scanning electron microscopy allowing the revelation of small coating defect, such as holes, cracks, etc., and also to control the thickness of the coated lower layer from cross-section and adhesion properties onto the resin coated support. The determination of gloss from coated samples was performed using Picogloss model 560 equipment from Erichsen Testing Equipment for 60° measurement.

### EXAMPLE 5

### Comparison Top Layer Formed From Polysaccharide (Viscogum vs PVA)

The experiments were carried out using a hand coater to apply the top overcoat based on Carrageenan or xanthan gum, associated with viscogum or PVA, onto ink receiving lower layer based on Pural/polysaccharides-PVA used as the lower layer from example 4. For the top layer coating, the various melt compositions for the top layer were varied from example 3 (3a to 3F). These inkjet melts were coated using a hand coater for a theoretical wet thickness about 200 μm. The operating conditions are summarized in Table 10.

TABLE 10
Operating conditions for hand-coater

| Parameters | Values | |
|---|---|---|
| Coating speed | 0.3 | ms⁻¹ |
| Wet thickness | 200 | μm |
| Coated surface area | 630 | cm² |
| Web temperature | 15° | C. |
| Coated solution volume | 20 | ml |
| Melt solution temperature | 60° | C. |

All coated experiments are summarized in Table 11 with comments in terms of coating quality, their gloss for 60° measurement. Furthermore, the printing properties were analyzed from printed chart tests for two inkjet printers HP Deskjet 5550 and EPSON stylus Photo 890. The printing properties were evaluated for image sharpness (ink: coalescence, spray and bleed; banding, bronzing), instant dryness. All printing features of the coating set are reported in Table 11.

The experimental series demonstrated that the gloss improvement and preservation of the instant dryness (HP printer) can be obtained for the combination of carrageenan and PVA compounds only. For the Epson printer, the use of top layer degraded the instant dryness and a high propensity for ink coalescence was observed (increased in presence of PVA compared to viscogum).

TABLE 11
Comparison for top layer varying polysaccharide in combination with
viscogum or PVA.

| | | | Printer | |
|---|---|---|---|---|
| | Coating/Remarks | Gloss | HP5550 | EPSON 890 |
| ME5 system | | | | |
| 3A | Some marks during | 27 | Good dryness, no | Not instant dry, |
| (viscogum) | the coating and are | | spray, no coalescence | coalescence, no spray |
| | increased after drying | | | |
| 3B | good homogeneity, no | 50 | Good dryness, no | Not instant dry, |
| (PVA) | markstraces, good | | spray, no coalescence | increased coalescence |
| | wettability | | | compared to 3A, no |
| | | | | spray |
| AMP45 | | | | |
| system | | | | |
| 3C | Good wettability, only | 27 | Good dryness, no | Not instant dry, but |
| (viscogum) | few traces after drying | | spray, no coalescence | decreased coalescence |
| | | | | propensity vs 3A & 3B, |
| | | | | no spray |
| 3D | Very homogeneous | 47 | Good dryness, no | Not instant dry, |
| (PVA) | coating without any | | spray, no coalescence | coalescence,, no spray |
| | wettability defect | | | |
| Xanthan | | | Printer | |
| system | Coating/Remark | Gloss | HP5550 | EPSON 890 |
| 3E | Relatively good | 35 | Not instant dry, little | Not instant dry, but |
| (viscogum) | homogeneity (few | | spray, no coalescence | decreased coalescence |
| | marks) | | | propensity, no spray |
| 3F | good homogeneity | 58 | Not instant dry, no | Not instant dry, but |
| (PVA) | | | spray, no coalescence | decreased coalescence |
| | | | | propensity, no spray |

### EXAMPLE 6

### Impact of the Top Layer Thickness Versus Gloss Level

The experiments were carried out using a hand coater to apply a upper overcoat based on Carrageenan-κ/PVA combination onto ink receiving lower layer based on Pural/polysaccharides-PVA from example 4 used as lower layer. For the upper layer coating, the melt composition from carrageenan-k (ME5, AMP45) in combination with polyvinyl alcohol from example 3B and 3D were used. These inkjet melts were coated using hand coater for a theoretical wet thickness about 50 or 200 μm. The operating conditions are summarized in Table 12.

TABLE 12
Operating conditions for hand-coater

| Parameters | Values | |
|---|---|---|
| Coating speed | 0.3 | ms⁻¹ |
| Wet thickness | 50-200 | μm |
| Coated surface area | 630 | cm² |
| Web temperature | 15° | C. |
| Coated solution volume | 10-20 | ml |
| Melt solution temperature | 60° | C. |

All coated samples exhibited good coating homogeneity, and the 60° gloss measurements are summarized in Table 13. All printing features of the coating set are reported in Table 13 as a function of the upper layer thickness and carrageenan type (Kappa vs Kappa/Iota) versus check lower layer coating.

TABLE 13
Gloss & printing property from carrageenan-κ/PVA upper layer

| | | | Printer HP5550 | | |
|---|---|---|---|---|---|
| | Top layer | | Inst. | Imag. | |
| ME5 system | (μm) | Gloss | Dryn. | Sharp. | Defect |
| Ex-3B | 50 | 49 | 1 | High | No |
| | 200 | 53 | 1 | High | No |
| | | | HP5550 | | |
| | Top layer | | Inst. | Imag. | |
| AMP45 system | (μm) | Gloss | Dryn. | Sharp. | Defect |
| Ex-3B | 50 | 49 | 1 | High | No |
| | 200 | 50 | 1 | High | No |
| | | | HP5550 | | |
| | Lower | | Inst. | Imag. | |
| Check | layer (μm) | Gloss | Dryn. | Sharp. | Defect |
| Ex-4 | 200 | 22 | 1 | High | No |

This preliminary experimental series demonstrated the drastic gloss improvement (at least 50 in place of 22) achieved using Carrageenan-κ/PVA or Carrageenan-κ/ι/PVA. The gloss improvement was not correlated to the upper layer thickness and preservation of the instant dryness for HP printer did not vary with the upper layer thickness.

### EXAMPLE 7

### Impact of PVA Level in Upper Layer

Preliminary efforts were carried out to recover instant dryness and reduce for the EPSON printer. The experimental series was done by varying the PVA level from 3 to 1% and maintaining the carrageenan-κ/ι (AMP45) at the previous level (0.7%, Ex-3D) in the upper layer. This was applied onto an ink receiving lower layer, used as bottom layer, based on Pural/polysaccharides-PVA from example 4. These inkjet melts were coated using a hand coater for a theoretical wet thickness about 200 μm. All coated samples exhibit good coating homogeneity and the gloss for 60° measurements are summarized in Table 14. The printing properties for this experimental series are also reported in Table 14.

TABLE 14
Impact PVA level on upper layer properties

| | | | Printer | | | | | |
|---|---|---|---|---|---|---|---|---|
| | | | HP5550 | | | EPSON 890 | | |
| AMP45 | | | Inst. | | | Inst. | Imag. | |
| system | PVA % | Gloss | Dryn. | Imag. Sharp. | Defect | Dryn. | Sharp. | Defect |
| Ex-7a | 1 | 49 | 1 | High | No | 3 | Medium | C(M), Ba(M) |
| EX-7b | 2 | 47 | 1 | High | No | 5 | Medium | C(H), Ba(H) |
| Ex-7c | 3 | 49 | 1 | High | No | 5 | Medium | C(H), Ba(H) |

These preliminary experiment produced improvement by reducing the PVA content to 1% (Ex-7a): instant dryness was improved (less dye report), coalescence was reduced.

### EXAMPLE 8

### Use of Fluorinated Surfactant in Top Layer

A comparative experiment was performed by replacing 10 G surfactant with Zonyl FSN, combined with PVA content at 1.5% and maintaining the carrageenan-κ/ι (AMP45) at the previous level (0.7%, Ex-3D) on an ink receiving lower layer based on Pural/polysaccharides-PVA from example 4. These inkjet melts were coated using a hand coater for a theoretical wet thickness about 200 μm. All coated samples exhibit good coating homogeneity and the gloss level for 60° measurements are summarized in Table 5. The printing properties for this experimental series are also reported in Table 15.

TABLE 15
Impact of surfactant in top layer on printing properties

| | | | Printer | | | | | |
|---|---|---|---|---|---|---|---|---|
| | | | HP5550 | | | EPSON | | |
| AMP45 | | | Inst. | | | Inst. | Imag. | |
| system | Surfact. | Gloss | Dryn. | Imag. Sharp. | Defect | Dryn. | Sharp. | Defect |
| Ex-8a | 10G | 49 | 1 | High | No | 3 | Medium | C(M), Ba(M) |
| EX-8b | Zonyl | 50 | 1 | High | No | 3 | Medium | C(L), Ba(L) |

The surfactant replacement (fluorinated Zonyl FSN) improved ink absorption from the upper layer to the receiving lower layer by reducing the ink coalescence propensity for the EPSON printer and reducing the banding phenomena.

### EXAMPLE 9

### Impact of the Carrageenan Content

An experimental series was prepared using the carrageenan-κ/ι (AMP45) at a lower level (0.35%) and varying the level of PVA and the level of potassium chloride (to influence the helix formation and aggregation for carrageenan), allowing reinforced gel formation at low carrageenan content, onto an ink receiving lower layer based on Pural/polysaccharides-PVA from example 4. The details of the inkjet melt composition used for the upper layer are reported in Table 16.

TABLE 16
Melt compositions varying addenda content

AMP45

| Example | Compoments | % active |
|---|---|---|
| 9a | AMP45 | 0.35 |
| | GH-23 | 1.5 |
| | KCL | 0.035 |
| | Zonyl FSN | 1 |
| 9b | AMP45 | 0.35 |
| | GH-23 | 1.5 |
| | Zonyl FSN | 1 |
| 9c | AMP45 | 0.35 |
| | KCL | 0.035 |
| | Zonyl FSN | 1 |
| 9d | AMP45 | 0.7 |
| | Zonyl FSN | 1 |

These inkjet melts were coated using a hand coater for a theoretical wet thickness about 50 μm. All coated samples exhibit good coating homogeneity and the 60° gloss measurements are summarized in Table17. The printing properties for this experimental series are also reported in Table 17.

TABLE 17
Printing properties of bilayer format with thinner upper layer

| | | Printer | | | | | |
|---|---|---|---|---|---|---|---|
| | | HP5550 | | | EPSON | | |
| Ex- | | Inst. | Imag. | | Inst. | Imag. | |
| ample | Gloss | Dryn. | Sharp. | Defect | Dryn. | Sharp. | Defect |
| 9a | 46 | 1 | High | No | 1 | High | C(L) |
| 9b | 45 | 1 | High | No | 2 | Good | C(L), Ba(L) |
| 9c | 42 | 1 | High | No | 2 | Good | C(L), Bl(L) |
| 9d | 36 | 1 | High | No | 1 | High | C(L) |

The reduction of the carrageenan or polyvinyl alcohol content does not drastically modify the gloss level (excepting 9d for higher carrageenan content without PVA compared with 9c). From printing properties, the changes are mainly observed for the EPSON printer: an improvement of the instant dryness was observed for the combination carrageenan/KCl/PVA with fluorinated surfactant or carrageenan at high content with fluorinated surfactant, allowing a drastic reduction in the printing defect (reduced banding phenomena, lower coalescence) to produce sharper images. These two combinations for thinner upper layer on an ink receiving lower layer based on Pural/polysaccharides-PVA for the lower layer provided a bilayer ink receiving media exhibiting good printing properties with gloss, compared to a matte surface for the lower layer alone, without any degradation of instant dryness properties.

### EXAMPLE 10

### Image Stability Comparison

The image stability was evaluated for light and ozone impact using an HP5550 printer mainly. For the EPSON printer, only light impact was documented. The printed densities were measured on Spectrolino equipment. For both light and ozone testing, the studies were done on maximum density for cyan (C), magenta (M), yellow (Y) and black (K) dyes. The light-fastness testing was performed for 50 kLux during 2 weeks: the result was expressed in % Dmax density loss.
Dmax density lost %=[(d_{L}−d_{O})/d_{O}]*100

With d_{O}=initial measured density

d_{L}=density measured after 2 weeks under light exposure

The ozone-fastness testing was carried out under 60 ppb ozone in dark room chamber for 3 weeks duration: the result was expressed in % Dmax density loss.
Dmax density lost %=[(d_{oz}−d_{O})/d_{O}]*100

With d_{O}=initial measured density
d_{oz}=density measured after 3 weeks ozone exposure

The image stability in terms of light-fastness and ozone-fastness was determined for both printers onto Dmax variability on check ink receiving lower layer based on Pural/polysaccharides-PVA, from example 4, used as lower layer versus the polysaccharides systems upper layers from example 9. The details of the inkjet melt composition used for the inkjet upper layer are reported in Table 18.

TABLE 18
Melt compositions varying addenda content

AMP45

| Example | Compoments | % active |
|---|---|---|
| 10a | AMP45 | 0.35 |
| | GH-23 | 1.5 |
| | KCL | 0.035 |
| | Zonyl FSN | 1 |
| 10b | AMP45 | 0.35 |
| | GH-23 | 1.5 |
| | Zonyl FSN | 1 |
| 10c | AMP45 | 0.35 |
| | KCL | 0.035 |
| | Zonyl FSN | 1 |
| 10d | AMP45 | 0.7 |
| | Zonyl FSN | 1 |

These inkjet melts were coated using a hand coater for a theoretical wet thickness of about 50 μm, excepting the experiment 10a coated for both 50 and 200 μm wet thickness. All coated samples exhibited good coating homogeneity and, after printing tests, all samples were submitted to light and ozone testing following standard exposure conditions previously described. All results are summarized in Table 19 versus mono lower layer (Ex-4) used as a check.

TABLE 19
Image preservation properties from light & ozone exposure

| Ex- | Top layer | HP5550 | | EPSON 890 | |
|---|---|---|---|---|---|
| periment | (μm) | Light | Ozone | Light | Ozone |
| Ex-4 | 0 | C = 18.6 | C = 52.6 | C = 0.0 | C = 35.5 |
| (Check) | | M = 18.2 | M = 70.1 | M = 42.0 | M = 64.6 |
| | | Y = 6.4 | Y = 15.4 | Y = 18.2 | Y = 7.0 |
| | | K = 16.4 | K = 56.8 | K = 14.8 | K = 29.7 |
| 10a | 50 | C = 1.8 | C = 21.2 | C = 0.0 | C = 9.3 |
| | | M = 7.0 | M = 12.6 | M = 51.6 | M = 2.6 |
| | | Y = 2.2 | Y = 0.0 | Y = 0.1 | Y = 0.0 |
| | | K = 6.1 | K = 12.3 | K = 4.1 | K = 8.7 |
| 10b | | C = 5.4 | C = 0 | C = 0.0 | C = 7.9 |
| | | M = 2.3 | M = 0 | M = 54.8 | M = 8.5 |
| | | Y = 5.4 | Y = 0.0 | Y = 0.0 | Y = 0.0 |
| | | K = 5.6 | K = 0.2 | K = 9.4 | K = 2.1 |
| 10c | | C = 7.9 | C = 4.3 | C = 0.0 | C = 0 |
| | | M = 16.3 | M = 73.4 | M = 69.2 | M = 4.2 |
| | | Y = 6.4 | Y = 5.9 | Y = 1.2 | Y = 0.0 |
| | | K = 14.6 | K = 14.8 | K = 11.4 | K = 0 |
| 10d | | C = 8.8 | C = 20.4 | C = 0.0 | C = 0.0 |
| | | M = 15.9 | M = 9.4 | M = 68.9 | M = 0.0 |
| | | Y = 6.3 | Y = 0.0 | Y = 1.9 | Y = 0.0 |
| | | K = 14.3 | K = 18.8 | K = 13.5 | K = 0.0 |
| 10a′ | 200 | C = 14.0 | C = 6.1 | C = 2.2 | C = 0.0 |
| | | M = 7.2 | M = 4.0 | M = 26.7 | M = 0.0 |
| | | Y = 11.0 | Y = 2.4 | Y = 2.8 | Y = 1.0 |
| | | K = 8.5 | K = 5.9 | K = 7.7 | K = 5.4 |

For the HP printer, the dyed images printed onto inkjet receiving media exhibited good image preservation properties for light exposure but high degradation was observed for ozone exposure (70% in magenta, 57% in black) for control Ex-4. The use of a upper thin layer (50 μm wet thickness) containing at least 0.7% carrageenan or carrageenan in combination with polyvinyl alcohol allowed a drastic improvement in the ozone-fastness, producing an acceptable level. The comparison between the experiments 10a and 10c demonstrate the synergy between carrageenan (at low content) and PVA to promote image preservation.

For the EPSON 890 printer, the dyed image printed onto ink receiving media exhibited good image preservation, excepting the loss in magenta (42%). To reduce the magenta loss to an acceptable level, a thicker upper layer (Ex-10a′) containing carrageenan (at low level) combined with PVA was required. For ozone exposure, a drastic density loss was observed in magenta (around 65%) and the use of thinner upper layer (50 μm wet thickness) composed from carragenan (at low content) alone or in combination with polyvinyl alcohol reduced ozone-fastness to an acceptable level.

### EXAMPLE 11

### Technology Extension to Zinc Oxide

Commercially available zinc oxide particles (99.9% purity exhibiting diameter below 1 μm, supplied by Aldrich, reference=205532) can be used as low cost absorbing material in inkjet media but the main drawbacks are related to poor saturated color (low printed density) and matte print. Based on high material porosity, the particles content was limited to 15% in weight. Two formulations based on zinc oxide were prepared from polyvinyl alcohol binder and polysaccharide associated to polyvinyl alcohol to be used as receiving bottom layer.

11-A PVA Formulation

Zinc oxide powder was dispersed in deionized water under magnetic stirring at room temperature. Then, the mixture was heated at 60° C. with constant stirring for 30 minutes. After a waiting period, polyvinyl alcohol supplied by Nippon Goshei as Gohsenol GH23 (used as 9% PVA in weight aqueous solution) was added at 60° C. with efficient stirring. The mixture was cooled at 50° C. and the stirring level was reduced to introduce the surfactant Zonyl FSN. To compensate for water evaporation, deionized water was added to obtain the required amount of mixture. The weight concentration are reported in Table 20.

TABLE 20
Zinc oxide dispersed in aqueous PVA

| | | % | | % |
|---|---|---|---|---|
| Components | Weight (g) | content* | active wt. (gms) | of solids |
| ZnO | 15.00 | 100.00 | 15.000 | 88.06 |
| GH-23 (sol 9%) | 18.16 | 9.00 | 1.634 | 9.59 |
| Zonyl FSN | 1.00 | 40.00 | 0.400 | 2.348 |
| g solids | 17.03 | | 17.034 | 100.00 |
| Water (g) | 84.77 | | | |
| total wt. | 118.93 | | | |

11-B PVA/Polysaccharide Formulation

Zinc oxide powder was dispersed in deionized water under magnetic stirring at room temperature. Then, the mixture was heated at 60° C. with stirring for 45 min. with ultraturrax homogeneizer before the addition of polysaccharides. At the same time, ME5 in a liquid solution state was added to the mixture with the viscogum BCR 13/80. Polyvinyl alcohol was supplied by Nippon Goshei as Gohsenol GH23 and used at 9% PVA in weight aqueous solution. Polyvinyl alcohol was introduced at 60° C. with efficient stirring. The mixture was cooled at 50° C. and the stirring level was reduced to introduce the surfactant 10 G. To compensate for water evaporation, deionized water was added to obtain 100 g of mixture. In order to achieve a good melt homogeneity, the mixture was stirred with an efficient homogeinizer at 8000 rpm at 50° C. for 30 minutes. The weight concentrations are reported in Table 21.

TABLE 21
Zinc oxide PVA-Polysaccharide aqueous formulation

| | | % | | % of |
|---|---|---|---|---|
| Components | Weight (g) | content* | active wt. (gms) | solids |
| Zno | 15.00 | 100.00 | 15.000 | 90.36 |
| ME5 (gel 1%) | 10.00 | 1.00 | 0.100 | 0.60 |
| viscogum (gel 1%) | 1.00 | 1.00 | 0.010 | 0.060 |
| GH-23 (sol 9%) | 11.00 | 9.00 | 0.990 | 5.96 |
| 10G surfactant | 2.50 | 20.00 | 0.500 | 3.01 |
| g solids | 16.60 | | 16.600 | 100.00 |
| Water (g) | 83.90 | | | |
| total wt. | 123.40 | | | |

11-C Top Layer Polysaccharides

Based on large porosity of the lower layer as a result of the zinc oxide particles size, the polysaccharides/PVA upper layer was formulated with high carrageenan content to induce a fast chill setting effect in the upper layer to avoid infiltration phenomena from upper to lower layer. The composition of the upper layer was reported in Table 22.

TABLE 22
Top layer formula

| | | % | | % |
|---|---|---|---|---|
| Components | Weight (g) | content* | active wt. (gms) | of solids |
| GH-23 (sol 9%) | 16.66 | 9.00 | 1.499 | 46.79 |
| ME5 (gel 3%) | 23.50 | 3.00 | 0.705 | 22.00 |
| Zonyl FSN | 2.50 | 40.00 | 1.000 | 31.21 |
| g solids | 3.20 | | 3.204 | 100.00 |
| Water (g) | 57.34 | | | |
| total wt. | 100.00 | | | |

The coating experiments were carried out using hand coater to perform lower and upper layers deposition on resin coated paper (coated with about 30 mg/ft² of gelatin applied using corona treatment in line). The coating parameters are reported in Table 23.

TABLE 23
Operating conditions for hand-coater

| Parameters | Bottom | Top |
|---|---|---|
| Coating speed | 0.3 ms⁻¹ | 0.3 ms⁻¹ |
| Wet thickness | 200 μm | 50 to200 μm |
| Coated surface area | 630 cm² | 630 cm² |
| Web temperature | 15° C. | 15° C. |
| Coated solution volume | 20 ml | 10 to 20 ml |
| Melt solution temperature | 60° C. | 60° C. |

The printing properties of the coating set was documented from HP5550 printer for both monolayer and bilayer samples. Both printing properties and gloss measurement are reported in Table 24.

The use of polysaccharide/PVA, versus PVA alone, does not change the gloss level and the printing properties obtained from HP5550 printer. The use of zinc oxide dispersed in PVA as a receiving lower layer does not achieve uniform deposit of the polysaccharides/PVA upper layer. This is evidenced by the unchanged gloss level, as the upper layer infiltrated into the bottom one.

The use of thick carrageenan/PVA upper layer allows recovery of the gloss feature and high dye density and good preservation of the instant dryness property. Furthermore, the use of carrageenan/PVA in the upper layer potentially allows reductions in the thickness of the lower layer, providing some manufacturing cost advantages.

TABLE 24
Printing properties and gloss from monolayer vs bilayers

| | | | Wet | | |
|---|---|---|---|---|---|
| | Bottom | Top | thickness | | |
| Structure | layer | layer | (μm) | Gloss 60° | Print quality |
| Monolayer | 11-A | | 200 | 2 | low dye density, unglossy feature, no |
| | | | | | blead or spray, good instant dryness |
| | 11-B | | 200 | 2 | low dye density, unglossy feature, no |
| | | | | | blead or spray, good instant dryness |
| | 11-B | | 50 | 2 | High dye density, unglossy feature, blead |
| | | | | | and spray, not instant dry |
| | 11-C | | 200 | 56 | High dye density, glossy and sharp image |
| | | | | | details, no blead coalescence or spray, |
| | | | | | good instant dryness |
| Bilayers | 11A | 11C | 200*/200 | 2 | low dye density, unglossy feature, no |
| | | | | | blead or spray, good instant dryness |
| | 11B | 11C | 200*/200 | 32 | High dye density, glossy and sharp image |
| | | | | | details, warmer color and contrast, no |
| | | | | | blead coalescence or spray, good instant |
| | | | | | dryness |
| | | | 50*/200 | 27 | High dye density, glossy and sharp image |
| | | | | | details, warmer color and contrast, no |
| | | | | | blead coalescence or spray, good instant |
| | | | | | dryness |
| | | | 50*/50 | 5 | High dye density, matte and sharp image |
| | | | | | details, warmer color and high contrast, |
| | | | | | no blead coalescence or spray, good |
| | | | | | instant dryness |

*first number indicating the bottom layer thickness

### Example 12

### Technology Extension to Calcium Carbonate

Commercially available calcium carbonate from Prolabo/VWR (exhibiting an averaged particle size=1.3 μm under powder form). The particle content was fixed to 33%. The composition of the calcium carbonate inkjet melt is reported in Table 25.

TABLE 25
Calcium carbonate bottom layer composition

| | | % | | % of |
|---|---|---|---|---|
| Components | Weight (g) | content* | active wt. (gms) | solids |
| CaCO3 | 34.4 | 95.8 | 32.96 | 95.49 |
| AMP45 (gel 3%) | 1.75 | 3.00 | 0.053 | 0.15 |
| Viscogum (gel 1%) | 0.50 | 1.00 | 0.005 | 0.01 |
| GH-23 (sol 9%) | 10.00 | 9.00 | 0.900 | 2.61 |
| 10G surfactant | 1.50 | 40.00 | 0.600 | 1.74 |
| g solids | 34.51 | | 34.513 | 100.00 |
| Water (g) | 53.85 | | | |
| total wt. | 100.00 | | | |

Calcium carbonate was added in water at 60° C. under magnetic stirring. A colloidal dispersion was formed then the temperature was increased to 80° C. After the carrageenan gel was remelted at 80° C. under magnetic stirring and added to the dispersion. The melt was stirred with ultra-turrax homogenizer at 8000 rpm until a homogeneous mixture was achieved. To complete the melt, the PVA GH23 was added under ultra-turrax stirring for 5 to 10 min. The surfactant was added under magnetic stirring after cooling the mixture at 50° C. The composition of the top layer is reported in Table 26.

TABLE 26
Composition of the top layer

| | | % | | % |
|---|---|---|---|---|
| Components | Weight (g) | content* | active wt. (gms) | of solids |
| GH-23 (sol 9%) | 16.66 | 9.00 | 1.499 | 52.58 |
| AMP45 (gel 3%) | 11.75 | 3.00 | 0.353 | 12.36 |
| FAC0029 | 2.50 | 40.00 | 1.000 | 35.06 |
| g solids | 2.85 | | 2.852 | 100.00 |
| Water (g) | 69.09 | | | |
| total wt. | 100.00 | | | |

The various coatings were applied, using the previous standard conditions, onto resin coated paper (coated with about 30 mg/ft² of gelatin applied using corona treatment in line). The printing performances and gloss measurements are reported in Table 27 for the check monolayer (bottom layer) and the bilayers (bottom layer+top layer), varying the layer thickness to examine the interaction between both layers. The printing performances are reported for HP5550 printer.

TABLE 27
Printing properties of calcium carbonate receiving layer with/without
top layer

| Ex- | | | | |
|---|---|---|---|---|
| peri- | | Coating | | |
| ment | Structure | thickness | Gloss | Print quality |
| 12-A | Bottom | 200 | 2 | Low color density, good instant |
| | layer | | | dryness, no coalescence, no |
| | | | | bleed, no spread |
| 12-B | Bottom | 50 | 2 | Medium dye density, good |
| | layer | | | instant dryness, no coalescence, |
| | | | | no bleed, no spread |
| 12-C | bottom | 50*/50 | 3 | Medium dye density, good |
| | layer + top | | | instant dryness, no coalescence, |
| | layer | | | no bleed, no spread |
| 12-D | bottom | 50*/200 | 12 | High dye density and warm |
| | layer + top | | | color, good instant dryness, no |
| | layer | | | coalescence, no bleed, no |
| | | | | spread |
| 12-E | bottom | 200*/200 | 6 | Medium dye density, good |
| | layer + top | | | instant dryness, no coalescence, |
| | layer | | | no bleed, no spread |

*first number corresponding to the bottom layer wet thickness

The use of large calcium carbonate particles size for ink receiving media does not achieve high color printed density as illustrated with the examples 12-A versus 12-B: an increased printed dyed density was observed for the thinner layer (50 μm in place of 200 μm wet thickness). To improve gloss level, the lower layer might be thinner than the upper layer to achieve a good smoothing of the upper layer surface to recover the gloss feature. The best compromise was achieved for the example 12-D, providing satin-like aspect and preserving the printing properties (high color printed density and instant dryness).

The invention has been described in detail with particular reference to certain preferred embodiments thereof, but it will be understood that variations and modifications can be effected within the spirit and scope of the invention.

1. An ink receiving media comprising at least two receiving layers on a support, wherein the layer closest to the support comprises inorganic particles, polysaccharide in combination with guar gum and polyvinyl alcohol, and the layer farthest from the support comprises polysaccharide in combination with polyvinyl alcohol.

2. The ink receiving media of claim 1 wherein said at least two receiving layers on a support comprise thermoreversible gels.

3. The inkjet receiving media of claim 1 wherein said polysaccharide comprises carrageenan κ or carrageenan κ/ι.

4. The ink receiving media of claim 1 wherein said layer closest to the support comprises from 0.07 to 3% by weight of polysaccharide.

5. The ink receiving media of claim 1 wherein said layer closest to the support comprises from 0.15 to 2% by weight of polysaccharide.

6. The ink receiving media of claim 1 wherein the weight fraction content ratio of polysaccharide between said layer farthest from the support and said layer closest to the support is from 2:1 to 20:1.

7. The ink receiving media of claim 1 wherein the weight fraction content ratio of polysaccharide between said layer farthest from the support and said layer closest to the support is from 7:1 to 14:1.

8. The ink receiving media of claim 1 wherein the weight fraction content ratio of polyvinyl alcohol between said layer farthest from the support and said layer closest to the support is from 1:1 to 10:1.

9. The ink receiving media of claim 1 wherein the weight content ratio of polyvinyl alcohol between said layer farthest from the support and said layer closest to the support is from 1:1 to 5:1.

10. The ink receiving media of claim 1 wherein said inorganic particles are inorganic porous particles.

11. The ink receiving media of claim 1 wherein said layer closest to the support comprises guar gum and polyvinyl alcohol of from 3 to 15% by weight.

12. The ink receiving media of claim 1 wherein said layer closest to the support comprises guar gum and polyvinyl alcohol of from 3 to 10% by weight.

13. The ink receiving media of claim 1 wherein said layer furthest from the support contains polysaccharide selected from the group consisting of carrageenan κ(kappa), carrageenan κ/ι (kappa/iota), and carrageenan ι (iota).

14. The ink receiving media of claim 1 wherein said layer furthest from the support comprises from 15 to 80% by weight of polysaccharide.

15. The ink receiving media of claim 1 wherein said layer closest to the support comprises from 25 to 70% by weight of polysaccharide.

16. The ink receiving media of claim 1 wherein said layer farthest from the support comprises a polyvinyl alcohol concentration of from 3 to 80% in weight.

17. The ink receiving media of claim 1 wherein said layer farthest from the support comprises a polyvinyl alcohol concentration of from 7 to 68% in weight.

18. The ink receiving media of claim 1 wherein said layer farthest from the support further comprises a weight content of from 5 to 25% of fluorinated surfactant.

19. The ink receiving media of claim 1 wherein said layer farthest from the support further comprises a hydroxylated polymer in addition to polyvinyl alcohol.

20. The ink receiving media of claim 1 wherein said ink receiving media is an inkjet receiving media.

21. The ink receiving media of claim 1 wherein said at least two receiving layers have a dried thickness of from 10 to 50 μm.

22. The ink receiving media of claim 1 wherein said layer closest to the support has a dried thickness of 25 μm.

23. An inkjet receiving media comprising at least two receiving layers on a support, wherein the layer closest to the support comprises inorganic particles, carrageenan K or carrageenan κ/ι in combination with guar gum and polyvinyl alcohol, and the layer farthest from the support comprises polymer materials based on carrageenan K or carrageenan κ/ι in combination with polyvinyl alcohol.

24. The inkjet receiving media of claim 23 wherein said at least two receiving layers on a support comprise thermoreversible gels.
